(19) United States
(12) Patent Application Publication
(10) Pub. No.: US 2025/0198177 A1
(43) Pub. Date: Jun. 19, 2025

(54) Nine-Degree-of-Freedom Intelligent Construction Platform

(71) Applicant: Weiguo Xu, Beijing (CN)

(72) Inventor: Weiguo Xu, Beijing (CN)

(21) Appl. No.: 18/772,176

(22) Filed: Jul. 14, 2024

(30) Foreign Application Priority Data
Dec. 13, 2023 (CN) 202311707643.5

(51) Int. Cl. E04G 21/16; B25J 5/00; B25J 5/04

(52) U.S. Cl. CPC E04G 21/16; B25J 5/007; B25J 5/04

(57) ABSTRACT

The invention discloses a Nine-Degree-of-Freedom Intelligent Construction Platform (Nine-DOF Intelligent Construction Platform), comprising a Mobile Vehicle Module, an Extended Carrier Module, a Robotic Arm, and a Lifting Platform Module. The Extended Carrier Module is assembled with the Mobile Vehicle Module along the translation direction. The Robotic Arm is assembled directly on the Mobile Vehicle Module or via the Lifting Platform Module. The invention utilizes a modular assembly approach. The Mobile Vehicle Module and the Extended Carrier Module accomplish autonomous movement and expand the range of precise positioning motion of the Robotic Arm. The Lifting Platform Module achieves lifting to provide more degrees of freedom for construction. Along with the modules, the Platform can meet the requirements of construction flexibility, real-time mobility, and positioning accuracy at the same time.

### TECHNICAL FIELD

This invention relates to the field of intelligent construction technology, more specifically, to a Nine-Degree-of-Freedom Intelligent Construction Platform (Nine-DOF Intelligent Construction Platform).

### TECHNICAL BACKGROUND

Intelligent construction technology refers to the construction process utilizing intelligent technology and related techniques. By employing smart systems, it enhances the level of intelligence in the construction process, reduces reliance on manual labor, and improves the safety, cost-effectiveness, and reliability of construction projects. The commonly adopted approach involves using robots or intelligent systems to replace humans in house construction. The technologies involved include Internet and Internet of Things (IoT) technology, CNC (Computer Numerical Control) machining, and intelligent construction technology with robotic arms. Among them, the intelligent construction of the robotic arm is a digital construction technology that carries out the masonry, lapping, cutting or additive manufacturing of building materials through the robotic arm, which offers advantages such as high precision, efficiency, intuitiveness, affordability, and high flexibility. The core equipment used in this technology is the robotic arm, which consists of the robotic arm itself and corresponding intelligent construction toolheads, with visual sensors, main control computers, joints and motors, which can mimic human arm movements and execute specific tasks in place. However, due to the limited reach of robotic arms constrained by arm length and their inherent immobility, robotic arm intelligent construction technology, as an emerging technology, still faces challenges in maturely applying it to practical construction sites. Therefore, in large-scale on-site intelligent construction, mobile platforms providing greater work ranges and more flexible site adaptability for robotic arms have emerged.

The robotic arm intelligent construction platform consists of a robotic arm and a mobile mechanism. The robotic arm is mounted on the mobile mechanism, wherein the robotic arm and its corresponding intelligent construction toolheads are responsible for executing intelligent construction actions, and the mobile mechanism provides mobility for the robotic arm, thereby expanding its working range.

Existing robotic arm intelligent construction platforms are mainly divided into three categories:

One type is a combination of a robotic arm and a track. In this configuration, the robotic arm typically has six axes, allowing it to construct at any angle due to its six degrees of freedom. However, the printing range is limited by its own mobility. The track can expand the range of motion of the robotic arm and offer high positioning accuracy. But the track needs to be laid according to the site conditions. So, the site flatness requirements are higher, and the mobility and real-time movement ability are poor.

Another type combines a robotic arm with a gantry. The robotic arm and its front-end toolhead are erected by a large-span gantry. This configuration is suitable for overall and large-volume construction projects due to the large size of the gantry. The robotic arm can only move along the Cartesian coordinate system on the gantry, and the gantry must be larger than the structure to be constructed, resulting in lower construction flexibility.

The last type combines a robotic arm with a mobile platform. The mobile platform can carry the robotic arm for movement and typically comes in wheeled or tracked structures. Wheeled and tracked platforms have certain obstacle-surmounting and real-time mobility capabilities but offer low positioning accuracy.

Therefore, providing a Nine-DOF Intelligent Construction Platform is a problem that technology professionals in this field urgently need to address.

### CONTENT OF INVENTION

In view of this, the present invention provides a Nine-DOF Intelligent Construction Platform that can simultaneously meet the requirements of construction flexibility, real-time mobility, and positioning accuracy.

To achieve the above objectives, the present invention adopts the following technical solution:

A Nine-DOF Intelligent Construction Platform (Nine-DOF Intelligent Construction Platform), comprising a Mobile Vehicle Module, an Extended Carrier Module, a Robotic Arm, and a Lifting Platform Module. The Extended Carrier Module is assembled with the Mobile Vehicle Module along the translation direction. The Robotic Arm is assembled directly on the Mobile Vehicle Module or via the Lifting Platform Module.

By adopting the above technical solution, the beneficial effects of the present invention are as follows:

The invention utilizes a modular assembly approach. The Mobile Vehicle Module and the Extended Carrier Module accomplish autonomous movement, and the linear guide rails on it meet the requirement of positioning accuracy. The Lifting Platform Module achieves lifting to provide more degrees of freedom for construction. Along with the modules, the Platform can meet the requirements of construction flexibility, real-time mobility, and positioning accuracy at the same time.

Furthermore, the Extended Carrier Module comprises a vehicle, No. 1 linear guide rails, a translational platform, and four locking seats. The No. 1 linear guide rails are mounted on the vehicle. The translational platform is mounted on No. 1 linear guide rails. The central part of the translational platform has the No. 1 mounting hole. The four locking seats are fixed at each corner of the translational platform's top. The Robotic Arm is mounted in the No. 1 mounting hole via bolts, and the Robotic Arm case and No. 1 linear guide rails' motor are installed on the translational platform. In another way, the bottom of the Lifting Platform Module is interlocked with the Mobile Vehicle Module via the locking seats, the Robotic Arm is mounted on the top of the Lifting Platform Module via bolts, and the Robotic Arm case and No. 1 linear guide rails' motor are installed in the Lifting Platform Module assembly.

The beneficial effect resulting from the aforementioned further technical solution is that, the autonomous movement of the Mobile Vehicle Module provides two degrees of freedom (XY plane). With the No. 1 linear guide rails parallel to the XY plane, the translational platform on the No. 1 linear guide rails can carry either the Robotic Arm alone or a combination of the Robotic Arm and the Lifting Platform, enabling precise movement and positioning of the Robotic Arm or the combination of the Robotic Arm and the Lifting Platform on the No. 1 linear guide rails.

Furthermore, the Mobile Vehicle Module assembly comprises the chassis, power system, drive system, control cabinet, and remote control. No. 1 linear guide rails are mounted on the top of the chassis; the driving system is installed at the bottom of the chassis; four No. 1 support legs are all mounted at the bottom of the chassis and are close to the dual-drive wheels of the drive system respectively; the control cabinet powered by the power system is installed on the chassis; the remote control is wirelessly connected with the control cabinet, and the control cabinet is electrically connected with the drive system.

The beneficial effect resulting from the aforementioned further technical solution is that, through remote control or autonomous navigation, it can carry out free movement and obstacle crossing on the construction site, thereby providing flexibility and maneuverability and adapting to construction sites with different terrains. Additionally, the No. 1 support legs can be retracted in driving simultaneously, while can be put down and landed when reaching the designated construction position, enhancing overall stability and ensuring that the position of the Mobile Vehicle remains stationary while the Robotic Arm is in motion.

Furthermore, the Mobile Vehicle Module assembly comprises a plurality of stoppers, and the stoppers are mounted on the vehicle and are respectively positioned at both ends of No. 1 linear guide rails.

The beneficial effect resulting from the aforementioned further technical solution is that, the Robotic Arm and the Lifting Platform Module are prevented from sliding out from both ends of the No. 1 linear guide rails. During the assembly of the Mobile Vehicle and the Extended Carrier Module, the stoppers at the joint can be moved to the other end to ensure that the Robotic Arm or the Lifting Platform can move along the joined guide rails.

Furthermore, the dual-drive wheels are equipped with a protective cover; foot pedals are mounted on the outer side of the chassis; leaf springs are mounted between the chassis and the drive system.

The beneficial effect resulting from the aforementioned further technical solution is that, the pedals can be used for people to get on and off, and the leaf springs play a shock-absorbing effect in movement.

Furthermore, the Extended Carrier Module assembly comprises a carrier, No. 2 linear guide rails, four No. 2 support legs, and a plurality of casters. The carrier is interlocked with the vehicle via bolts; No. 2 linear guide rails are mounted on the top of the carrier and assembled with No. 1 linear guide rails; four No. 2 support legs are all mounted at the four corners of the carrier respectively; the casters are installed at the bottom of the carrier.

The beneficial effect resulting from the aforementioned further technical solution is the ability to transport the Robotic Arm or the combination of the Robotic Arm and the Lifting Platform for movement, thereby expanding its moving range.

Furthermore, the Lifting Platform Module assembly comprises a quadruple linkage screw lift; a lifting platform, and a lift control cabinet. The locking points on the bottom shell of the quadruple linkage screw lift are interlocked with the locking seats. The lifting platform is mounted on the top of the quadruple linkage screw lift. The central part of the lifting platform has the No. 2 mounting hole. The Robotic Arm is mounted in the No. 2 mounting hole via bolts. The lift control cabinet and the robotic arm control cabinet are fixed between the quadruple linkage screw lift. The control circuit board of the control cabinet is electrically connected with the motor in the lift control cabinet. The robotic arm control cabinet is electrically connected with the No. 1 linear guide rails' motor and the Robotic Arm.

The beneficial effect resulting from the aforementioned further technical solution is the ability to transport the Robotic Arm for forward and backward movement on the No. 1 or No. 2 linear guide rails, while simultaneously providing one degree of freedom to lift the Robotic Arm, thereby expanding its working range in the Z-direction for construction.

Furthermore, a cable carrier is installed between the Lifting Platform Module and the Mobile Vehicle Module.

The beneficial effect resulting from the aforementioned further technical solution is that, during the reciprocating motion of the Lifting Platform and the Robotic Arm, it provides traction and protection for the built-in cables, hydraulic hoses, and other components.

Furthermore, the top of the Lifting Platform Module is equipped with the rings; ladders are mounted on the outer side of the quadruple linkage screw lift.

The beneficial effect resulting from the aforementioned further technical solution is to facilitate lifting or handling operations.

Furthermore, the outer periphery of the screws of the quadruple linkage screw lift are equipped with dust covers.

The beneficial effect resulting from the aforementioned further technical solution is to prevent the accumulation of dust and dirt on the screw shafts at the construction site.

### FIGURE CAPTION

To provide a clearer illustration of the embodiments of the present invention or the technical solutions in the prior technology, a brief introduction to the drawings required in the description of the embodiments or the prior technology will be provided below. It is evident that the below drawings are merely embodiments of the present invention. For those skilled in the field, additional drawings can be obtained based on the provided drawings without the need for creative effort.

FIG. 1 illustrates an exploded view of a Nine-DOF Intelligent Construction Platform provided by the present invention.

FIG. 2 illustrates the structural schematic of the Mobile Vehicle Module provided by the present invention.

FIG. 3 illustrates the structural schematic of the Extended Carrier Module provided by the present invention.

FIG. 4 illustrates the structural schematic of the Lifting Platform Module provided by the present invention.

FIG. 5 illustrates a schematic diagram of the overall structure of a Nine-DOF Intelligent Construction Platform in Example 1 of the present invention.

FIG. 6 illustrates a schematic diagram of the overall structure of a Nine-DOF Intelligent Construction Platform in Example 2 of the present invention.

### EXEMPLARY EMBODIMENT

The technical solutions in the embodiments of the present invention will be clearly and completely described below in conjunction with the accompanying drawings in the embodiments of the present invention, and it is obvious that the described embodiments are only part of the embodiments of the present invention, not all embodiments. Based on the embodiments in the present invention, all other embodiments obtained by those skilled in the field without making creative labor belong to the scope of protection of the present invention.

### Embodiment 1

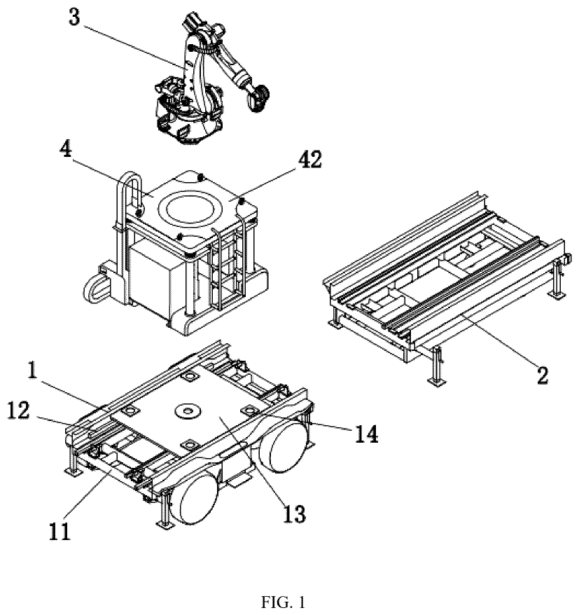

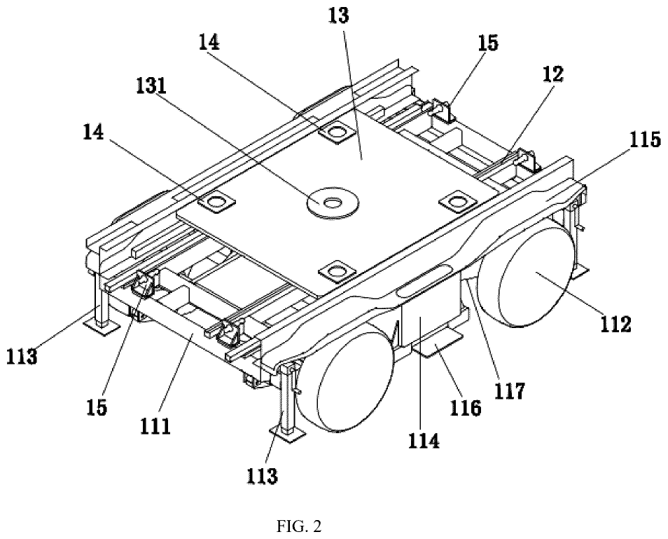

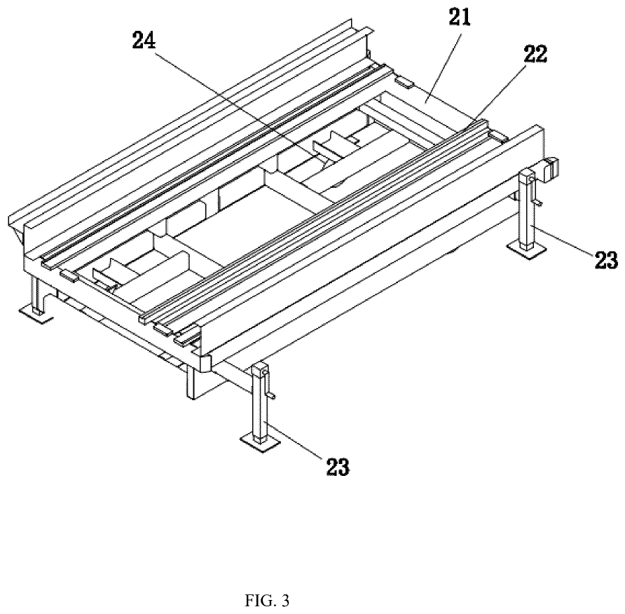

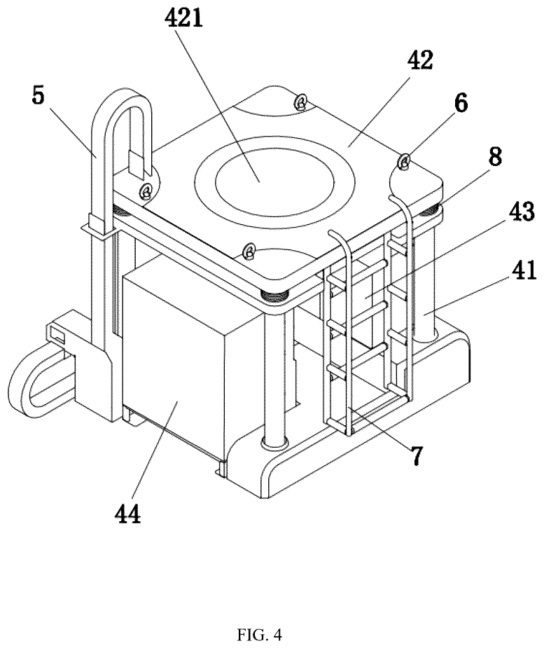

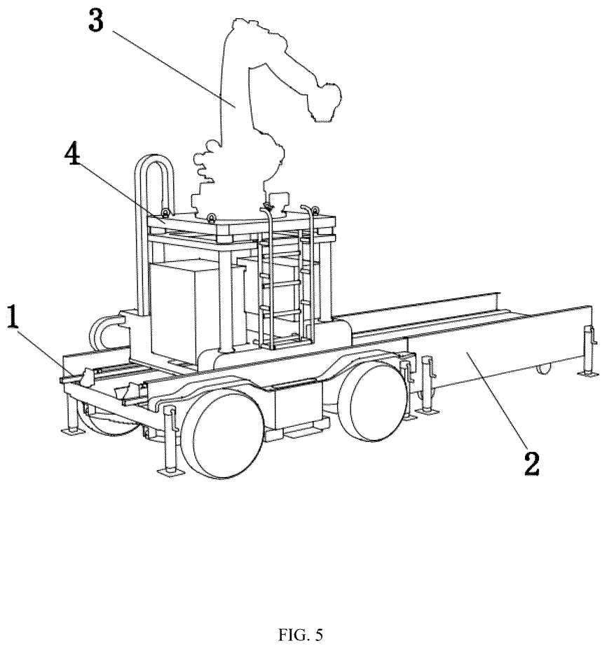

As shown in FIGS. 1 to 5, the embodiments of the present invention disclose a Nine-DOF Intelligent Construction Platform for the in-situ printing construction of large-scale and two-story concrete buildings, including a Mobile Vehicle Module 1, an Extended Carrier Module 2, a Robotic Arm 3, and a Lifting Platform Module 4. The Robotic Arm 3 is an existing robotic arm, providing six degrees of freedom. By installing different intelligent construction toolheads at the end, it can adapt to various construction scenarios, serving as the primary actuator for intelligent construction. The Extended Carrier Module 2 is joined together with the Mobile Vehicle Module 1 along the translational direction. The Robotic Arm 3 is mounted to the top of the Mobile Vehicle Module 1 via the Lifting Platform Module 4. The modules of the present invention are assembled using modular combinations, on the one hand, it facilitates transportation and assembly of each module, can effectively reduce transportation costs. On the other hand, the modular assembly of different modules allows the platform to adapt to various construction requirements and scenarios. The Mobile Vehicle Module 1 and the Extended Carrier Module 2 achieve autonomous movement, enabling them to move within a larger range. The linear guide rails on them ensure precise positioning accuracy. The Lifting Platform Module 4 enables vertical movement, allowing the Robotic Arm 3 to have a larger range of motion along the Z-axis. This capability enables the construction of buildings with two or more stories, providing greater freedom for intelligent construction. It can simultaneously meet the requirements for construction flexibility, real-time mobility, and positioning accuracy.

Specifically, the Mobile Vehicle Module 1 comprises a vehicle 11, No. 1 linear guide rails 12, a translational platform 13, and four locking seats 14. The No. 1 linear guide rails 12 are mounted on the vehicle 11. The No. 1 linear guide rails 12 come in various forms, including ball, roller, and cylindrical linear guide rails, which can be selected based on different conditions of the construction site. The translational platform 13 is mounted on the No. 1 linear guide rails 12. The central part of the translational platform 13 has a No. 1 mounting hole 131. Four locking seats 14 are fixed at the four corner positions of the top of the translational platform 13. The bottom of the Lifting Platform Module 4 is locked with the locking seats 14. The Robotic Arm 3 is mounted on the top of the Lifting Platform Module 4 via bolts. The Robotic Arm control case and the motor of the No. 1 linear guide rails 12 are mounted within the Lifting Platform Module 4. The translational platform 13 on the No. 1 linear guide rails 12 can carry a combination of the Robotic Arm 3 and the Lifting Platform Module 4, enabling precise movement and positioning of the combination of the Robotic Arm 3 and the Lifting Platform Module 4 on the No. 1 linear guide rails 12.

Specifically, the vehicle 11 consists of a chassis 111, a power system, a driving system 112, a control cabinet 114, and a remote controller. The No. 1 linear guide rails 12 is mounted on the top of the chassis 111. The driving system 112 is installed at the bottom of the chassis 111. The four No. 1 support legs 113 of the chassis 111 are all mounted on the main body of the chassis 111 and are positioned near the dual-drive wheels of the driving system 112. In the stationary state, the No. 1 support legs 113 can be extended to provide support, preventing the chassis from tipping over when the upper modules are moved forward or backward. The No. 1 support legs 113 can be adjusted in height to regulate the height of the chassis 111 and can also be inserted into the ground for fixation. The control cabinet 114, powered by the power system, is installed on the chassis 111. The remote controller is wirelessly connected to the control cabinet 114, which is electrically connected to the driving system 112. The dual-drive wheels of the driving system 112 can autonomously move in any direction on the plane. Through remote control or navigation, the vehicle 11 can freely move on the construction site, overcoming obstacles, and adapting to different terrain conditions, providing flexibility and maneuverability.

To further optimize the technical solution of the present invention, the Mobile Vehicle Module 1 assembly comprises a plurality of stoppers 15. The stoppers 15 are mounted on the vehicle 11 and are respectively positioned at both ends of No. 1 linear guide rails 12 to prevent the Robotic Arm 3 and the Lifting Platform Module 4 from sliding out from both ends of the No. 1 linear guide rails 12. During the assembly of the Mobile Vehicle 11 and the Extended Carrier Module 21, the stoppers 15 at the joint can be moved to the other end to ensure that the Robotic Arm 3 or the Lifting Platform 4 can move along the joined guide rails.

To further optimize the technical solution of the present invention, the dual-drive wheels in the chassis 111 are equipped with a protective cover 115; foot pedals 116 are mounted on the outer side of the chassis 111, which can be used for people to get on and off; leaf springs 117 are mounted between the chassis 111 and the drive system 112 and play a shock-absorbing effect in movement.

Specifically, the Extended Carrier Module 2 assembly comprises a carrier 21, No. 2 linear guide rails 22, four No. 2 support legs 23, and a plurality of casters 24. The carrier 21 is interlocked with the vehicle 11 via bolts. The No. 2 linear guide rails 22 are mounted on the top of the carrier 21 and assembled with No. 1 linear guide rails 21, forming longer guide rails, which facilitates the movement of the combination of the Robotic Arm 3 and the Lifting Platform Module 4, thereby expanding the range of movement. In this embodiment, the carrier 21 can be combined and assembled with the vehicle 11 along the direction of the guide rails in any combination, allowing for arbitrary combinations. This ensures that the length of the track meets any requirements on the construction site. Additionally, the carrier 21 can be customized according to the requirements of the construction site, including track length and curved tracks, to meet on-site requirements at a lower cost. The four No. 2 support legs are all mounted at the four corners of the carrier respectively. Multiple casters 24 are installed at the bottom of the carrier 21, which can be pushed by constructors to achieve mobility and obstacle avoidance on-site.

Specifically, the Lifting Platform Module 4 assembly comprises a quadruple linkage screw lift 41; a lifting platform 42, and a lift control cabinet 43. The locking points on the bottom shell of the quadruple linkage screw lift 41 are interlocked with the locking seats 14. The lifting platform 42 is mounted on the top of the quadruple linkage screw lift 41. The central part of the lifting platform 42 has the No. 2 mounting hole 421. The Robotic Arm 3 is mounted in the No. 2 mounting hole 421 via bolts. The Robotic Arm 3 can be carried and moved forward and backward on the No. 1 linear guide rails 12 or the No. 2 linear guide rails 22, providing an additional degree of freedom. It can also lift the Robotic Arm 3, expanding its working range in the Z-direction for construction purposes. The lift control cabinet 43 and the robotic arm control cabinet 44 are fixed between the quadruple linkage screw lift 41. The control circuit board of the control cabinet 114 is electrically connected with the motor in the lift control cabinet 41. The robotic arm control cabinet 44 is electrically connected with the No. 1 linear guide rails 12′ motor and the Robotic Arm 3. Of course, it can also serve as an external axis for the Robotic Arm 3, moving in coordination with the Robotic Arm 3.

To further optimize the technical solution of the present invention, a cable carrier 5 is installed between the Lifting Platform Module 4 and the Mobile Vehicle Module 1. During the reciprocating motion of the Lifting Platform 4 and the Robotic Arm 3, it provides traction and protection for the built-in cables, hydraulic hoses, and other components.

To further optimize the technical solution of the present invention, the top of the lifting platform 42 is equipped with the rings 6 to facilitate lifting or handling operations. In this embodiment, handrails can be installed on the lifting rings 6 to protect the safety of construction crews on the lifting platform 42. Ladders 4 are mounted on the outer side of the quadruple linkage screw lift 41.

To further optimize the technical solution of the present invention, the outer periphery of the screws of the quadruple linkage screw lift 41 are equipped with dust covers 8.

The working process of the present invention is as follows: Firstly, the four modules of the Mobile Vehicle Module 1, the Extended Carrier Module 2, the Robotic Arm 3, and the Lifting Platform Module 4 are transported separately to the construction site. Then, the Robotic Arm 3, the Lifting Platform Module 4, and the Mobile Vehicle Module 1 are assembled into a whole. The 3D printing concrete tool head is installed on the Robotic Arm 3 and connected to other printing equipment. After determining the starting position for construction, the vehicle 11 carries the Robotic Arm 3 and the Lifting Platform Module 4 to the starting position via remote control or intelligent navigation. The carrier 21 is attached to the vehicle 11 to extend the length of the guide rail track. The No. 1 support legs 113 and the No. 2 support legs 23 are lowered respectively. The Robotic Arm 3 performs in situ printing of the foundation, walls, and other building components. During printing, the Robotic Arm 3 and the lifting platform 42 move along the No. 1 linear guide rails 12 or the No. 2 linear guide rails 22. During construction, the Robotic Arm 3 moves on the assembled guide rails and prints the foundation and the first-floor wall within the working range of the machine site. After printing is completed, the vehicle 11 carries the Robotic Arm 3 and the lifting platform 42 to the next printing position via remote control or autonomous navigation. The carrier 21 is pushed by construction crews to connect to the end of vehicle 11. The Robotic Arm 3 continues to print the foundation and the first-floor wall at the second position, and so on. After printing all positions of the first-floor foundation and walls, the lifting platform 42 is raised, and the Robotic Arm 3 prints the second-floor walls on top of the first-floor walls. This process is repeated until the on-site printing is completed. Alternatively, during printing, a height control method involving the coordinated control of the Robotic Arm 3 and the lifting platform 42 can be adopted. When printing each segment of the wall, the Robotic Arm control cabinet 44 and the lifting control cabinet 43 work together to print all heights of the walls within the working range of the machine site. After printing is completed, the vehicle 11 carries the Robotic Arm 3 and the lifting platform 42 to the next printing position via remote control or autonomous navigation. The carrier 21 is pushed by construction workers to connect to the end of the vehicle 11. The Robotic Arm 3 continues to print all heights of the walls at the second position.

### Embodiment 2

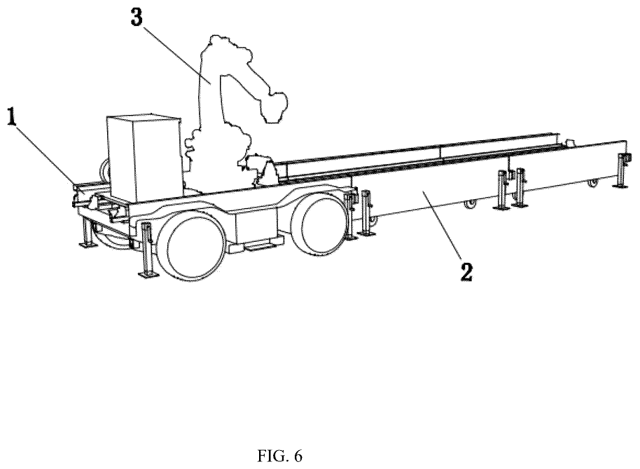

As shown in FIGS. 1 to 3 and 6, the embodiments of the present invention disclose a Nine-DOF Intelligent Construction Platform for the in-situ printing construction of long-planed wooden buildings on a single floor, including a Mobile Vehicle Module 1, a plurality of Extended Carrier Modules 2, a Robotic Arm 3. The Robotic Arm 3 is an existing robotic arm, providing six degrees of freedom. By mounting different intelligent construction toolheads at the end, it can adapt to various construction scenarios, serving as the primary actuator for intelligent construction. The Extended Carrier Module 2 is joined together with the Mobile Vehicle Module 1 along the translational direction. The Robotic Arm 3 is mounted to the top of the Mobile Vehicle Module 1. The modules of the present invention are assembled using modular combinations, on the one hand, it facilitates transportation and assembly of each module, can effectively reduce transportation costs. On the other hand, the modular assembly of different modules allows the platform to adapt to various construction requirements and scenarios. The Mobile Vehicle Module 1 and the Extended Carrier Module 2 achieve autonomous movement, enabling them to move within a larger range. The linear guide rails on them ensure precise positioning accuracy. It can simultaneously meet the requirements for construction flexibility, real-time mobility, and positioning accuracy.

Specifically, the Mobile Vehicle Module 1 comprises a vehicle 11, No. 1 linear guide rails 12, a translational platform 13, and four locking seats 14. The No. 1 linear guide rails 12 are mounted on the vehicle 11. The No. 1 linear guide rails 12 come in various forms, including ball, roller, and cylindrical linear guide rails, which can be selected based on different conditions of the construction site. The translational platform 13 is mounted on the No. 1 linear guide rails 12. The central part of the translational platform 13 has a No. 1 mounting hole 131. Four locking seats 14 are fixed at the four corner positions of the top of the translational platform 13. The Robotic Arm 3 is mounted at the No. 1 mounting hole 131 via bolts. The Robotic Arm control case and the motor of the No. 1 linear guide rails 12 are mounted on the translational platform 13. The translational platform 13 on the No. 1 linear guide rails 12 can carry a combination of the Robotic Arm 3, enabling precise movement and positioning of the combination of the Robotic Arm 3 on the No. 1 linear guide rails 12.

Specifically, the vehicle 11 consists of a chassis 111, a power system, a driving system 112, a control cabinet 114, and a remote controller. The No. 1 linear guide rails 12 is mounted on the top of the chassis 111. The driving system 112 is installed at the bottom of the chassis 111. The four No. 1 support legs 113 of the chassis 111 are all mounted on the main body of the chassis 111 and are positioned near the dual-drive wheels of the driving system 112. In the stationary state, the No. 1 support legs 113 can be extended to provide support, preventing the chassis from tipping over when the upper modules are moved forward or backward. The No. 1 support legs 113 can be adjusted in height to regulate the height of the chassis 111 and can also be inserted into the ground for fixation. The control cabinet 114, powered by the power system, is installed on the chassis 111. The remote controller is wirelessly connected to the control cabinet 114, which is electrically connected to the driving system 112. The dual-drive wheels of the driving system 112 can autonomously move in any direction on the plane. Through remote control or navigation, the vehicle 11 can freely move on the construction site, overcoming obstacles, and adapting to different terrain conditions, providing flexibility and maneuverability.

To further optimize the technical solution of the present invention, the Mobile Vehicle Module 1 assembly comprises a plurality of stoppers 15. The stoppers 15 are mounted on the vehicle 11 and are respectively positioned at both ends of No. 1 linear guide rails 12 to prevent the Robotic Arm 3 and the Lifting Platform Module 4 from sliding out from both ends of the No. 1 linear guide rails 12. During the assembly of the Mobile Vehicle 11 and the Extended Carrier Module 21, the stoppers 15 at the joint can be moved to the other end to ensure that the Robotic Arm 3 or the Lifting Platform 4 can move along the joined guide rails.

To further optimize the technical solution of the present invention, the dual-drive wheels in the chassis 111 are equipped with a protective cover 115; foot pedals 116 are mounted on the outer side of the chassis 111, which can be used for people to get on and off; leaf springs 117 are mounted between the chassis 111 and the drive system 112 and play a shock-absorbing effect in movement.

Specifically, the Extended Carrier Module 2 assembly comprises a carrier 21, No. 2 linear guide rails 22, four No. 2 support legs 23, and a plurality of casters 24. The carrier 21 is interlocked with the vehicle 11 via bolts. The No. 2 linear guide rails 22 are mounted on the top of the carrier 21 and assembled with No. 1 linear guide rails 21, forming longer guide rails, which facilitates the movement of the Robotic Arm 3, thereby expanding the range of movement. In this embodiment, the carrier 21 can be combined and assembled with the vehicle 11 along the direction of the guide rails in any combination, allowing for arbitrary combinations. This ensures that the length of the track meets any requirements on the construction site. Additionally, the carrier 21 can be customized according to the requirements of the construction site, including track length and curved tracks, to meet on-site requirements at a lower cost. The four No. 2 support legs are all mounted at the four corners of the carrier respectively. Multiple casters 24 are installed at the bottom of the carrier 21, which can be pushed by constructors to achieve mobility and obstacle avoidance on-site.

The working process of the present invention is as follows: Firstly, t the Mobile Vehicle Module 1, the Extended Carrier Modules 2, the Robotic Arm 3 are separately transported to the construction site. Then, the Robotic Arm 3 and the Mobile Vehicle Module 1 are assembled into a whole, and the Robotic Arm 3 is equipped with an intelligent tool head for wood construction. After determining the starting position for construction, the vehicle 11 carries the Robotic Arm 3 to the starting position via remote control or intelligent navigation. Multiple carriers 21 are connected to the vehicle 11 to extend the length of the guide rail track. The No. 1 support legs 113 and the No. 2 legs 23 are lowered. During construction, the servo motor drives the Robotic Arm 3 to move on the guide rail. The Robotic Arm 3 is controlled by the robotic arm control cabinet to perform construction tasks. After completing construction at one position, the vehicle 11 and the carrier 21 are moved to the next position for continued construction until the on-site construction is completed.

The embodiments described in this specification are presented progressively, with each embodiment focusing on the differences from the others. The common and similar aspects between the embodiments can be cross-referenced. For devices disclosed in the embodiments, since they correspond to the methods disclosed in the embodiments, their descriptions are relatively simple, and relevant details can be found in the method section.

The above description of the disclosed embodiments enables those skilled in the field to implement or use the present invention. It will be apparent to those skilled in the field that various modifications to these embodiments are possible. The general principles defined herein may be applied in other embodiments without departing from the spirit or scope of the invention. Therefore, the present invention is not limited to the embodiments shown herein but encompasses the widest scope consistent with the principles and novel features disclosed herein.

What is claimed is:

1. A Nine-Degree-of-Freedom Intelligent Construction Platform (Nine-DOF Intelligent Construction Platform), comprising a Mobile Vehicle Module, an Extended Carrier Module, a Robotic Arm, and a Lifting Platform Module; the Extended Carrier Module is assembled with the Mobile Vehicle Module along the translation direction; the Robotic Arm is assembled with the top of the Mobile Vehicle Module, or the Robotic Arm is assembled on the top of the Mobile Vehicle Module through the Lifting Platform Module.

2. The Nine-DOF Intelligent Construction Platform of claim 1, wherein the Mobile Vehicle Module assembly comprises a vehicle, No. 1 linear guide rails, a translational platform, and four locking seats; the No. 1 linear guide rails are mounted on the vehicle; the translational platform is mounted on No. 1 linear guide rails; the central part of the translational platform has the No. 1 mounting hole; the four locking seats are fixed at each corner of the translational platform's top; the Robotic Arm is mounted in the No. 1 mounting hole via bolts, and the Robotic Arm case and No. 1 linear guide rails' motor are installed on the translational platform; in another way, the bottom of the Lifting Platform Module is interlocked with the Mobile Vehicle Module via the locking seats, the Robotic Arm is mounted on the top of the Lifting Platform Module via bolts, and the Robotic Arm case and No. 1 linear guide rails' motor are installed in the Lifting Platform Module assembly.

3. The Nine-DOF Intelligent Construction Platform of claim 2, wherein the vehicle assembly comprises the chassis, power system, drive system, control cabinet, and remote control; the No. 1 linear guide rails are mounted on the top of the chassis; the driving system is installed at the bottom of the chassis; four No. 1 support legs are all mounted at the bottom of the chassis and are close to the dual-drive wheels of the drive system respectively; the control cabinet powered by the power system is installed on the chassis; the remote control is wirelessly connected with the control cabinet, and the control cabinet is electrically connected with the drive system.

4. The Nine-DOF Intelligent Construction Platform of claim 2, wherein the Mobile Vehicle Module assembly comprises a plurality of stoppers, and the stoppers are mounted on the vehicle and are respectively positioned at both ends of No. 1 linear guide rails.

5. The Nine-DOF Intelligent Construction Platform of claim 3, wherein the dual-drive wheels are equipped with a protective cover; foot pedals are mounted on the outer side of the chassis; leaf springs are mounted between the chassis and the drive system.

6. The Nine-DOF Intelligent Construction Platform of claim 2, wherein the Extended Carrier Module assembly comprises a carrier, No. 2 linear guide rails, four No. 2 support legs, and a plurality of casters; the carrier is interlocked with the vehicle via bolts; No. 2 linear guide rails are mounted on the top of the carrier and assembled with No. 1 linear guide rails; four No. 2 support legs are all mounted at the four corners of the carrier respectively; the casters are installed at the bottom of the carrier.

7. The Nine-DOF Intelligent Construction Platform of claim 2, wherein the Lifting Platform Module assembly comprises a quadruple linkage screw lift, a lifting platform, and a lift control cabinet; the locking points on the bottom shell of the quadruple linkage screw lift are interlocked with the locking seats; the lifting platform is mounted on the top of the quadruple linkage screw lift; the central part of the lifting platform has the No. 2 mounting hole; the Robotic Arm is mounted in the No. 2 mounting hole via bolts; the lift control cabinet and the robotic arm control cabinet are fixed between the quadruple linkage screw lift; the control circuit board of the control cabinet is electrically connected with the motor in the lift control cabinet; the robotic arm control cabinet is electrically connected with the No. 1 linear guide rails' motor and the Robotic Arm.

8. The Nine-DOF Intelligent Construction Platform of claim 1, wherein a cable carrier is mounted between the Lifting Platform Module and the Mobile Vehicle Module.

9. The Nine-DOF Intelligent Construction Platform of claim 7, wherein the top of the Lifting Platform Module is equipped with the rings; ladders are mounted on the outer side of the quadruple linkage screw lift.

10. The Nine-DOF Intelligent Construction Platform of claim 7, wherein the outer periphery of the screws of the quadruple linkage screw lift are equipped with dust covers.
